(19) United States
(12) Patent Application Publication
(10) Pub. No.: US 2011/0168841 A1
(43) Pub. Date: Jul. 14, 2011

(54) AIR PASSENGER SEAT WITH A FASTENING DEVICE FOR FASTENING A CHILD SEAT

(75) Inventor: Sven Achilles, Michelfeld (DE)

(73) Assignee: RECARO Aircraft Seating GmbH & Co. KG, Schwabisch Hall (DE)

(21) Appl. No.: 12/990,412

(22) PCT Filed: Apr. 18, 2009
(86) PCT No.: PCT/EP2009/002840

§ 371 Date: Jan. 14, 2011

(30) Foreign Application Priority Data
May 2, 2008 (DE) 10 2008 021 999.1

(51) Int. Cl. B64D 11/06

(52) U.S. Cl. 244/122 R

(57) ABSTRACT

An air passenger seat with at least one basic body unit and a fastening device which is fastened to the basic body unit and is provided for fastening a child seat. It is proposed that the fastening device has an intersecting point for connecting to a fastening means of the child seat, said intersecting point being connected rigidly to the basic body unit.

### CROSS REFERENCE TO RELATED APPLICATIONS

This application is a U.S. national stage application of PCT/EP2009/002840 filed on Apr. 18, 2009, and claims priority to, and incorporates by reference, German patent application No. 10 2008 021 999.1 filed on May 2, 2008.

### BACKGROUND

The invention is based on an air passenger seat and on a method for fastening a child seat to an air passenger seat.

An air passenger seat with a fastening device for fastening a child seat is known. The fastening device comprises a strap system which is fastened to a basic body unit of the air passenger seat.

It is the particular object of the invention to provide an air passenger seat of the generic type with a fastening device for fastening a child seat, by which the child seat can be fastened particularly robustly and securely and by which a high level of operating convenience can be achieved.

### SUMMARY

The invention is based on an air passenger seat with at least one basic body unit and a fastening device which is fastened to the basic body unit and is provided for fastening a child seat.

It is proposed that the fastening device has an interface member for connecting to a fastening member of the child seat, said interface member being rigidly connected to the basic body unit. As a result, the child seat can be robustly and securely fastened. Furthermore, the level of operating convenience can be enhanced, since it is possible to omit adjusting the position of the interface member relative to the basic body unit, said adjustment being necessary in particular in the event of fastening by means of a strap system. An “interface member” for connecting to a fastening member of the child seat is intended in particular to mean a portion of the fastening device, said portion coming into contact with the fastening member of the child seat during fastening of the child seat. A “rigid connection” of the interface member to the basic body unit is intended in particular to mean a connection in which the interface member is immovable relative to the basic body unit. In particular, said rigid connection can be achieved by means of a connecting body which directly connects the interface member to the basic body unit and is designed as a rigid body. As an alternative, the interface member can be fastened directly to the basic body unit. Furthermore, a particularly robust fastening can be achieved if the fastening device is nondetachable from the basic body unit. However, in another embodiment, a high degree of flexibility in the use of the fastening device can be achieved if the fastening device is designed to be detachable from the basic body unit. “Provided” is intended in particular to mean specially equipped or specially designed.

A “basic body unit” of the air passenger seat is intended in particular to mean an air passenger seat unit which, owing to the size thereof, the dimensions thereof and/or the arrangement thereof in the air passenger seat, in particular has a carrying function and/or which is provided specifically to lead off forces.

The fastening device can be fastened particularly robustly if the air passenger seat has a carrier unit for carrying a functional member of the air passenger seat, which functional member is designed as a seat part or back structure, the basic body unit being designed as part of the carrier unit. In particular, the basic body unit can be formed by at least one supporting member for supporting the functional member, which supporting member is directly coupled to the functional member.

In another embodiment, it is conceivable for the basic body unit to be formed by a functional member of the air passenger seat, such as, in particular, by a seat part or a backrest structure. In this case, the fastening device having the interface member can be fastened directly to the seat part and/or to the backrest structure.

It is also proposed that the basic body unit is rigidly connected to an aircraft cabin floor when the air passenger seat is in use. This advantageously enables a rigid connection between the interface member and the aircraft cabin floor to be achieved by means of the basic body unit. This is suitable in particular for air passenger seats in which at least the seat part is designed to be fixed relative to the aircraft cabin floor. However, in an alternative embodiment, it is conceivable for the basic body unit to be designed to be movable relative to the aircraft cabin floor. This is suitable in particular for air passenger seats in which the seat part is designed to be movable relative to the aircraft cabin floor. In this case, the basic body unit is advantageously fixedly connected to the seat part, as a result of which the fastening device and a child seat fastened therewith can accompany movements of the seat part.

A particularly robust arrangement of the basic body unit and, as a result, of the fastening device can be achieved if the basic body unit is rigidly connected to a supporting tube unit mounted on the aircraft cabin floor. The supporting tube unit here preferably has a pair of parallel supporting tubes which can extend parallel to the aircraft cabin floor and can serve to connect a plurality of air passenger seats in a seat row.

Furthermore, structural parts and construction space can be saved if the basic body unit is formed by the supporting tube unit. In this case, the fastening device can be fastened directly to the supporting tube unit. Moreover, the interface member can be directly fastened to the supporting tube unit.

It is furthermore proposed that the interface member is arranged in a rear region of the air passenger seat, which region is defined relative to a flying direction, thus enabling advantageous compatibility of the fastening device with conventional child seats to be achieved.

The level of operating convenience can be further enhanced if the interface member is provided in order, in interaction with the fastening member, to form a rapid connection system for fastening the child seat. A “rapid connection system” which is formed by the interface member and the fastening member is intended in particular to mean a system which is provided to produce a fastening connection between the interface member and the fastening member without using a tool.

In a preferred embodiment of the invention, it is proposed that the interface member has at least one latching member, thus enabling a particularly low effort to be achieved in the fastening of the child seat. In particular, a rapid connection system with which a fastening operation can be realized can be achieved in this case in a particularly simple manner, with it being possible to dispense with manual actuation of the fastening member of the child seat or of the interface member of the air passenger seat. In a particularly advantageous manner, the fastening can be carried out merely by the user moving the child seat relative to the interface member. A “latching member” is intended in particular to mean a member which is provided in order to produce a latching connection to the fastening member.

In this context, it is proposed that the latching member is designed as a latching opening. This enables particularly simple adaptation to conventional fastening members of child seats, in particular of child seats used in the automobile sector, which have gripping members for engaging in the latching opening. The latching opening can be formed, for example, by a latching clip, a latching eye, etc. As a result, the fastening device can advantageously be suitable for the use of child seats having standardized fastening members.

Furthermore, it is proposed that the interface member is provided in order to interact with at least one gripping arm of the child seat, as a result of which advantageous compatibility with a high number of child seat models can be achieved.

A particularly low effort in the fastening of the child seat can be achieved if the air passenger seat has a seat part forming a seat surface, the fastening device being provided for fastening the child seat in a position supported on the seat surface. In this case, a connection between the interface member and the fastening member of the child seat can be achieved if the interface member is arranged at least level with the seat surface relative to an aircraft cabin floor.

In another embodiment of the invention, it is proposed that the air passenger seat has a backrest cushion and a seat cushion, the interface member being arranged in the contact region between the backrest cushion and the seat cushion. As a result, an easily accessible but visually inconspicuous arrangement of the interface member can be achieved. The “contact region” between the backrest cushion and the seat cushion is intended in particular to mean the region in which the backrest cushion and the seat cushion are in contact. In said contact region, the interface member is preferably in contact with the backrest cushion and the seat cushion.

Furthermore, the invention is based on a method for fastening a child seat to an air passenger seat. It is proposed that the child seat is fastened to an interface member of the air passenger seat, which interface member is rigidly connected to a basic body unit of the air passenger seat, thus enabling the child seat to be robustly and securely fastened. Furthermore, the level of operating convenience can be enhanced, since it is possible to dispense with adjustment of the position of the interface member relative to the basic body unit of the air passenger seat, which adjustment is necessary in particular in a fastening by means of a strap system.

The level of operating convenience can be further enhanced if, for fastening purposes, the child seat is moved relative to the interface member and the movement causes the actuation of a rapid connection system, in particular a latching system.

### BRIEF DESCRIPTION OF THE DRAWINGS

Other advantages emerge from the description below of the drawing. The drawing illustrates exemplary embodiments of the invention. The description and the claims contain numerous features in combination. A person skilled in the art will expediently also consider the features individually and put them together to form meaningful further combinations.

FIG. 1 is an air passenger seat with a child seat arranged on a seat surface,

FIG. 2 is a partial region of the air passenger seat, with a fastening device for fastening the child seat,

FIG. 3 is the interaction of a latching clip of The fastening device and of a gripping arm of the child seat, and

FIG. 4 is a partial region of a further air Passenger seat with an alternative arrangement of the fastening device on a supporting tube.

### DETAILED DESCRIPTION OF THE PREFERRED EMBODIMENTS

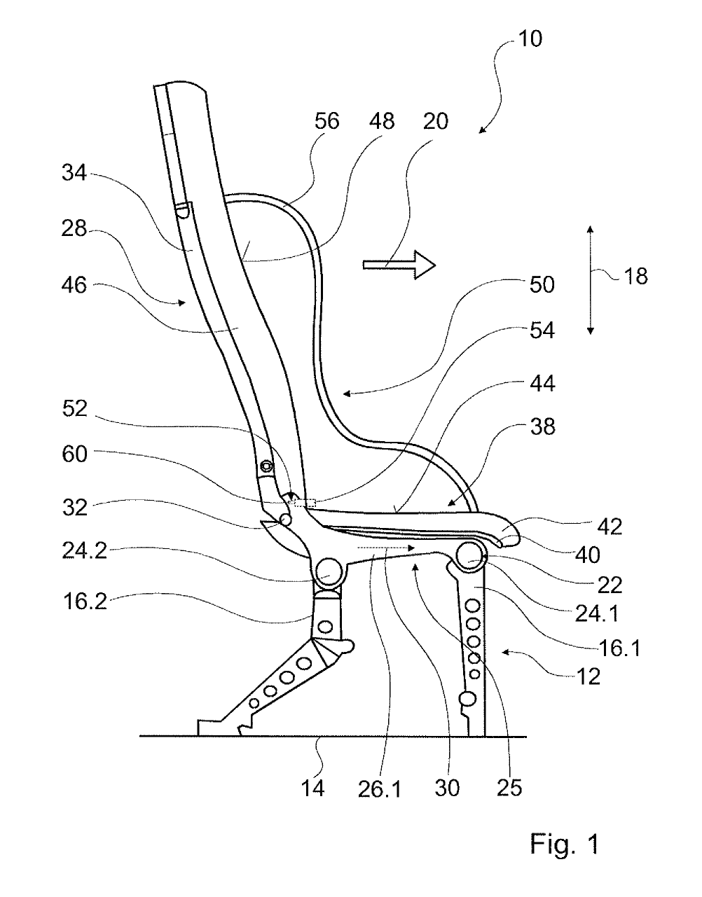

FIG. 1 shows a greatly simplified illustration of an air passenger seat 10 in a side view. The air passenger seat 10 has a seat structure 12 which comprises a set of leg members 16 which are fixed to an aircraft cabin floor 14 and extend substantially in the vertical direction 18 perpendicular to the aircraft cabin floor 14. The leg members 16 form pairs, wherein one pair in each case comprises a front leg member 16.1, which is arranged in the front region of the air passenger seat relative to a flying direction 20, and a rear leg member 16.2, which is arranged in the rear region of the air passenger seat 10 relative to the flying direction 20. A supporting tube unit 22 is in engagement with the leg members 16.1, 16.2, with a front supporting tube 24.1 in the front region of the air passenger seat 10, which supporting tube 24.1 is in engagement with the front leg member 16.1, and with a rear supporting tube 24.2 in the rear region of the air passenger seat 10, which supporting tube 24.2 extends parallel to the front supporting tube 24.1 and is in engagement with the rear leg member 16.2. The supporting tube unit 22 is therefore mounted on the aircraft cabin floor 14 by means of the seat structure 12. The supporting tubes 24 which are each guided in an opening of a leg member 16 which is left open at the upper end of the respective leg member 16 extend parallel to the aircraft cabin floor 14. A plurality of air passenger seats 10 of the generic type can be connected to one another by means of the supporting tube unit 22. In particular, a supporting tube unit 22 typically serves to connect together air passenger seats 10 which form a seat row oriented perpendicularly to the flying direction 20.

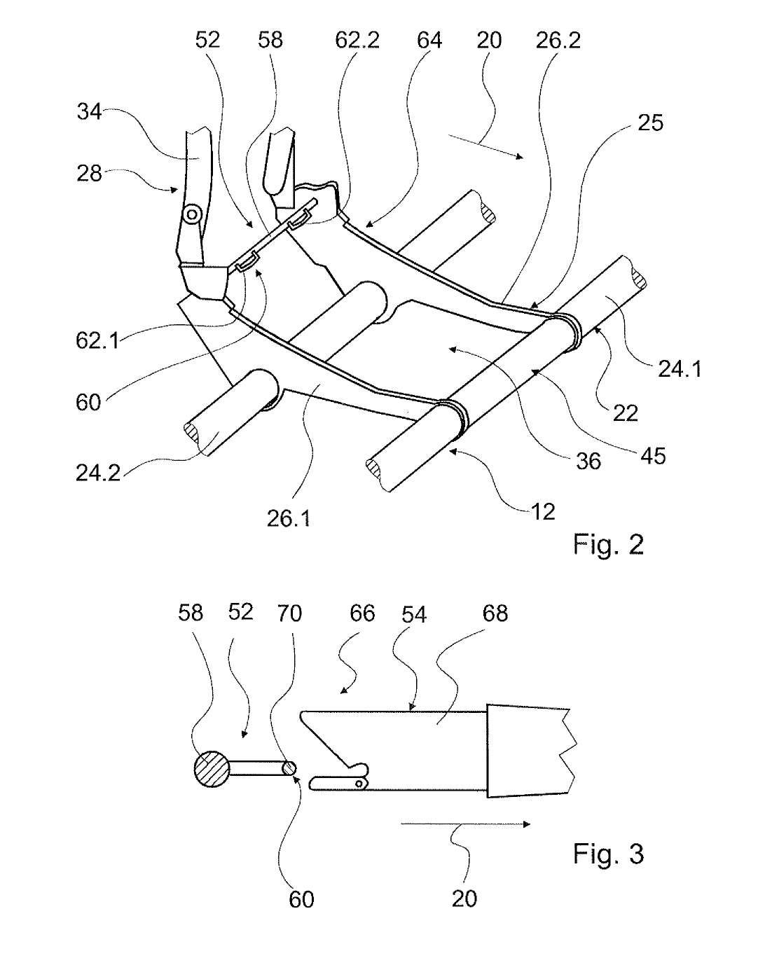

The following description refers to FIG. 1 and FIG. 2 in which a part of the air passenger seat 10 that is carried by the leg member 16 is shown in an oblique view. The air passenger seat 10 furthermore has a carrier unit 25 which is provided for carrying a backrest structure 28. For this purpose, the carrier unit 25 has a pair of supporting members 26.1, 26.2 which are spaced apart from each other in a direction perpendicular to the flying direction 20, are oriented parallel to each other and are rigidly coupled to the supporting tube unit 22. Only the supporting member 26.1 can be seen in FIG. 1 while the pair of supporting members 26.1, 26.2 can be seen in the oblique view of FIG. 2. The supporting members 26 are each designed as an elongate component, the main direction of extent 30 of which is oriented parallel to the aircraft cabin floor 14 and to the flying direction 20. Said supporting members 26.1, 26.2 each have a bearing point 32 by means of which the backrest structure 28 is mounted pivotably on the supporting member 26. The backrest structure 28 has a frame 34 which is of U-shaped design and connects the supporting members 26.1, 26.2 to each other (see FIG. 2). Respective circular openings in which the front supporting tube 24.1 and the rear supporting tube 24.2 are guided are provided in the front and rear regions of the supporting members 26. The supporting tubes 24.1, 24.2 are therefore connected to each other by a supporting member 26. The supporting members 26 serve in particular to lead off a force exerted on the backrest structure 28 to the supporting tube unit 22. The supporting members 26 furthermore border a seat part portion 36 (FIG. 2) in which a seat part 38, which is shown in FIG. 1, is arranged. The seat part 38 has a seat base 40, which is designed as a seat pan, and a seat cushion 42 which is fastened to the seat base 40. The seat cushion 42 forms a seat surface 44. The seat base 40 is fastened to the supporting tubes 24 by means of a fastening device (not illustrated specifically) which preferably has a clip holder. The supporting tube unit 22 therefore serves as a carrier unit 45 for carrying the seat part 38. In the fastened state, the seat part 38 is arranged between two supporting members 26 in the seat part portion 36. A backrest cushion 46 which forms a backrest surface 48 is furthermore provided on the backrest structure 28.

In the view of FIG. 1, a child seat 50 is furthermore fastened to the air passenger seat 10. For the fastening of the child seat 50, the air passenger seat 10 has a fastening device 52 which is illustrated in a greatly schematic manner in FIG. 1 and is in fixed engagement with a fastening member 54 of the child seat 10. The fastening device 52 is illustrated in more detail below with reference to FIG. 2. The fastening device 52 is provided by means of the arrangement thereof relative to the seat part 38 in order, in the fastened state, to fasten the child seat 50 in a position supported on the seat surface 44. The child seat 50 furthermore has a backrest 56 which, in the fastened state of the child seat 50, bears against the air passenger seat 10, specifically against the backrest surface 48 of the air passenger seat 10.

As can be gathered from FIG. 2, the fastening device 52 has a carrying member 58 which bears an interface member 60 for connecting to the fastening member 54 of the child seat 50. The interface member 60 is intended to be understood as meaning that part of the fastening device 52 which comes into contact with the fastening member 54 of the child seat 50 during the fastening of the child seat 50. The interface member 60 has two fastening elements which are designed as latching members 62.1, 62.2 and are spaced apart from each other in a direction perpendicular to the flying direction 20. Other fastening element embodiments appearing expedient to a person skilled in the art are conceivable. The latching members 62.1, 62.2 can be built separately from the carrying member 58 or they can be formed integrally with the carrying member 58. The carrying member 58 of the fastening device 52, which carrying member 58 is designed as a rod in the present exemplary embodiment, is fastened to the supporting members 26.1, 26.2 positioned opposing each other. Accordingly, the support elements 26.1, 26.2 form a basic body unit 64 of the air passenger seat 10, to which basic body unit the fastening device 52 is fastened. A plurality of kinds of fastening, appearing expedient to a person skilled in the art, for fastening the fastening device 52 to the basic body unit 64, such as, for example, a weld joint, an interlocking connection, in particular a latching connection or a screw coupling, are conceivable. With the fastening of the fastening device 52, specifically of the carrying member 58 which is designed as a rigid body, to the basic body unit 64, the interface member 60 is rigidly connected to the basic body unit 64. The basic body unit 64 is part of the carrier unit 25. Since said carrier unit 25 is fastened to the supporting tube unit 22 which itself is mounted via the leg members 16 on the aircraft cabin floor 14 and is rigidly connected thereto, a rigid connection is produced between the basic body unit 64 and the aircraft cabin floor 14. As a result, a rigid connection is produced between the interface member 60 and the aircraft cabin floor 14, thus making it advantageously possible, in the fastened state of the child seat 50, to produce a rigid connection between the child seat 50 and the aircraft cabin floor 14. By the basic body unit 64 being designed as a supporting member 26.1, 26.2, said basic body unit is rigidly coupled to the two supporting tubes 24.1, 24.2 of the supporting tube unit 22, thus enabling a particularly high degree of stability to be achieved with the child seat 50 by a fastening operation.

The interface member 60 of the fastening device 52 is designed in a specific manner in order to form, together with the fastening member 54 of the child seat 50, a rapid connection system 66 so as to rapidly fasten the child seat 50, in particular without using a tool. By means of the rapid connection system 66, a secure fastening connection can be produced in a simple manner by relative movement of the fastening member 54 of the child seat 50 with respect to the interface member 60 without further installation steps, in particular manual actuation of the fastening member 54, having to be introduced by the user. In this case, the fastening member 54 of the child seat 50 and the interface member 60 of the air passenger seat 10 interact in such a manner that said movement causes the automatic actuation of the rapid connection system 66. The interface member 60, which has the two latching members 62.1, 62.2, is provided in order to produce a latching connection to the fastening member 54. Furthermore, said interface member is adapted so as to interact with a system of gripping arms 68 of the child seat 50. For this purpose, the latching members 62.1, 62.2 are each designed as latching openings, in particular in the form of latching clips, which are arranged on the carrying member 58. During fastening of the child seat 50, the spaced-apart latching clips come into engagement with two gripping arms 68 of the child seat 50. This is illustrated in FIG. 3 which shows a gripping arm 68 of the child seat 50 engaging around a latching clip. In particular, a portion 70 of the latching clip, which portion 70 extends parallel to the carrying member 58 and is spaced apart from the carrying member 58 in the flying direction 20, is engaged around by the gripping arm 68.

In the fitted state of the air passenger seat 10, the interface member 60 is arranged in the rear region of the air passenger seat 10. In particular, the interface member 60 is located in a region which is arranged above the rear supporting tube 24.2 with respect to the vertical direction 18. As can be gathered from FIG. 1, the interface member 60 is arranged between the seat cushion 42 and the backrest cushion 46. Owing to this arrangement of the interface member 60, the arrangement being concealed in the contact region of the backrest cushion 46 with the seat cushion 42, said interface member is not visible to a person standing in front of the air passenger seat 10. The position of the interface member 60 in the flying direction 20 relative to the front edge of the seat part 38 is selected in such a manner that said interface member is arranged outside the seating region of the air passenger seat 10 such that the comfort of a seated person is not affected. In the present example, the interface member 60 is furthermore arranged at a height relative to the aircraft cabin floor 14, the height being selected in such a manner that the interface member 60 is level with the seat surface 44, and therefore the gripping arms 68 of the child seat 50 come into engagement with the latching members 62 when said child seat is pushed along the seat surface 44. This is suitable for conventional child seats in which the gripping arms 68 constitute a continuation of the lower side of the seat part of the child seat. An arrangement of the interface member 60 in other regions, said arrangement being selected specifically for other types of child seats, is likewise conceivable.

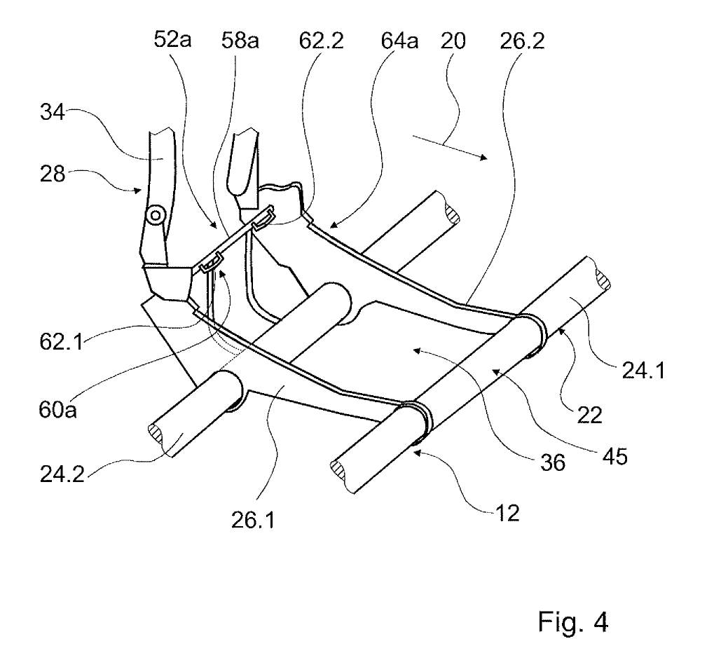

FIG. 4 shows an alternative exemplary embodiment of an air passenger seat 10 according to the invention. For the sake of clarity, components which have the same function as in the above exemplary embodiment are referred by the same reference numbers, wherein, in order to clarify a difference in the embodiment, the letter a is added to the reference number. In order to avoid repetitions, the description below is restricted to the differences over the above exemplary embodiment.

In said further variant embodiment, a fastening device 52a for fastening the child seat 50 is fastened to the supporting tube unit 22, specifically said fastening device is directly coupled to the rear supporting tube 24.2 of the supporting tube unit 22. In this configuration, the supporting tube unit 22 forms a basic body unit 64a to which the fastening device 52a is fastened. The fastening device 52a has an interface member 60a which likewise has two fastening elements which are spaced apart from each other and are designed as latching members 62. Said latching members 62 are rigidly connected to the basic body unit 64a via a carrying member 58a fastened to the rear supporting tube 24.2. The basic body unit 64a is formed integrally with the supporting tube unit 22 and accordingly constitutes part of the carrier unit 45 for carrying the seat part 38.

In the exemplary embodiments mentioned above, the basic body unit 64 is in each case rigidly connected to the aircraft cabin floor 14. By this means, increased safety in the fastening of a child seat can be achieved—in particular with respect to conventional fastenings of child seats by means of a strap system.

In other embodiments of an air passenger seat 10, in particular in air passenger seats in an elevated category of comfort, the seat part 38 can be arranged movably relative to the aircraft cabin floor 14. In this case, it is advantageous if the basic body unit, to which the fastening device 52 is rigidly connected, is rigidly connected to the seat part 38. As a result, during movements of the seat part 38 relative to the aircraft cabin floor 14, a child seat 50 arranged on the seat surface 44 formed by the seat part 38 can accompany the movements of said seat part.

1. An air passenger seat comprising:
at least one basic body unit and a fastening device which is fastened to the basic body unit and is provided for fastening a child seat, wherein
the fastening device has an interface member for connecting to a fastening member of the child seat, said interface member being rigidly connected to the basic body unit.

2. The air passenger seat as claimed in claim 1, further comprising
a functional member which is designed as a seat part or backrest structure, and a carrier unit for carrying the functional member, the basic body unit being designed as part of the carrier unit.

3. The air passenger seat as claimed in claim 1, wherein the basic body unit is rigidly connected to an aircraft cabin floor when the air passenger seat is in use.

4. The air passenger seat as claimed in claim 3, wherein the basic body unit is rigidly coupled to a supporting tube unit mounted on the aircraft cabin floor.

5. The air passenger seat as claimed in claim 4, wherein the basic body unit is formed by the supporting tube unit.

6. The air passenger seat as claimed in claim 1, further comprising
a rear region which is defined relative to a flying direction and in which the interface member is arranged.

7. The air passenger seat as claimed in claim 1, wherein the interface member is provided in order, in interaction with the fastening member, to form a rapid connection system for fastening the child seat.

8. The air passenger seat as claimed in claim 1, wherein the interface member has at least one latching member.

9. The air passenger seat as claimed in claim 8, wherein the latching member is designed as a latching opening.

10. The air passenger seat as claimed in claim 1, wherein the interface member is provided in order to interact with at least one gripping arm of the child seat.

11. The air passenger seat as claimed in claim 1, further comprising
a seat part forming a seat surface, the fastening device being provided for fastening the child seat in a position supported on the seat surface.

12. The air passenger seat as claimed in claim 1, further comprising
a backrest cushion and a seat cushion, the interface member being arranged in the contact region between the backrest cushion and the seat cushion.

13. A system with an air passenger seat as claimed in claim 1 and with a child seat which has a child seat fastening member which is suitable for interaction with the interface member.

14. A method for fastening a child seat to an air passenger seat, in particular as claimed in claim 1, wherein the child seat is fastened to an interface member of the air passenger seat, which interface member is rigidly connected to a basic body unit of the air passenger seat.

15. The method as claimed in claim 14, wherein, for fastening purposes, the child seat is moved relative to the interface member and the movement causes the actuation of a rapid connection system, in particular a latching system.
